(19) United States
(12) Patent Application Publication
(10) Pub. No.: US 2007/0048564 A1
(43) Pub. Date: Mar. 1, 2007

(54) Fuel cell combining a stack and a reformer

(75) Inventors: Sun-Wei Chang, Taipei City (TW); Min-Hsien Lin, Taipei City (TW); Yin-Pu Chen, Taipei City (TW); Chien-Wen Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/374,958

(22) Filed: Mar. 15, 2006

(30) Foreign Application Priority Data
Aug. 30, 2005 (TW) 094214919

(51) Int. Cl. H01M 8/06

(52) U.S. Cl. 429/20

(57) ABSTRACT

The present invention is related to a fuel cell combining a stack and a reformer, which comprises a stack having a coupling part and a reformer having a conjugate part. The conjugate part of the reformer may couple to the coupling part of the stack. The full cell according to the present invention reduces the volume, fully utilizes thermal energy, and reduces the use of raw materials to minimize expenses.

### BACKGROUND OF THE INVENTION

1. Field of the Invention

The present invention is related to a fuel cell; and more particularly, a fuel cell combining a stack and a reformer.

2. Description of Related Art

A conventional fuel cell differs from a generally used cell in that fuel cell transforms energy instead of storing it. Such a fuel cell is indeed a device for transforming chemical energy to electrical energy and has the advantage of efficient transformation, zero pollution, low noise, long life-span, etc. As fuel and oxidant are continuously supplied via an external source to the fuel cell, the fuel cell may constantly generate electric power.

Please refer to FIG. 3 for illustration of a prior fuel cell system that comprises a reformer and a stack. The reformer transforms fuel into hydrogen for the stack to use. The stack transforms the hydrogen into low-voltage direct current. Household electricity is generally of the alternating current system. An electrical transformer is therefore required to transform the low-voltage direct current into 110/220V ac for the use of loading.

Referring to FIG. 3, when the reformer transfers fuel into hydrogen for the stack to use, the reformer has to process control of feeding (of fuel, refrigerant, air, etc), temperature, pressure, analysis, flow rate, and heat-eliminating via reformer control system. Similarly, the stack must process control of feeding (of hydrogen, refrigerant, air, etc), temperature, pressure, loading variation and heat-elimination via stack control system. The reformer and stack are apart and each comprises a reformer control system and stack control system to process various monitoring. It is obvious that due to that the reformer and the stack being apart, the volume of prior fuel cell system is enormous. Moreover, separated control of the reformer and stack is not economically sufficient.

### SUMMARY OF THE INVENTION

The present invention discloses a fuel cell combining a reformer and a stack. The fuel cell according to the present invention may reduce volume, fully utilize thermal energy, reduce the use of raw materials, and cut down expenses.

The fuel cell according to the present invention comprises a stack having a coupling part and a reformer having a conjugate part. The conjugate part of the reformer may couple to the coupling part of the stack. Both the coupling part and conjugate part of the stack and reformer are planar in shape. The stack and reformer may be coupled and integrated into a single entity.

The reformer of the fuel cell according to the present invention comprises a first heat pipe and a second heat pipe. The stack comprises a first introducer and a second introducer. The first introducer of the stack connects to the first heat pipe of the reformer. Moreover, the second introducer of the stack connects to the second heat pipe of the reformer.

The reformer of the fuel cell according to the present invention comprises a hydrogen pipe extending from the conjugate part of the reformer. The stack comprises a hydrogen intake pipe extending from the coupling part of the stack. The hydrogen pipe of the reformer connects to the hydrogen intake pipe of the stack.

The first and second heat pipes of the stack according to the present invention extend the conjugate part of the reformer. The first and second introducers extend the coupling part of the stack.

### BRIEF DESCRIPTION OF THE DRAWINGS

FIG. 1 is an exploded diagram of the reformer and stack of the fuel cell according to the present invention;

FIG. 2 is the diagram of the reformer and stack of the fuel cell according to the present invention; and

FIG. 3 is the flow chart of the electricity production and transfer of prior fuel cell and electrical transformer.

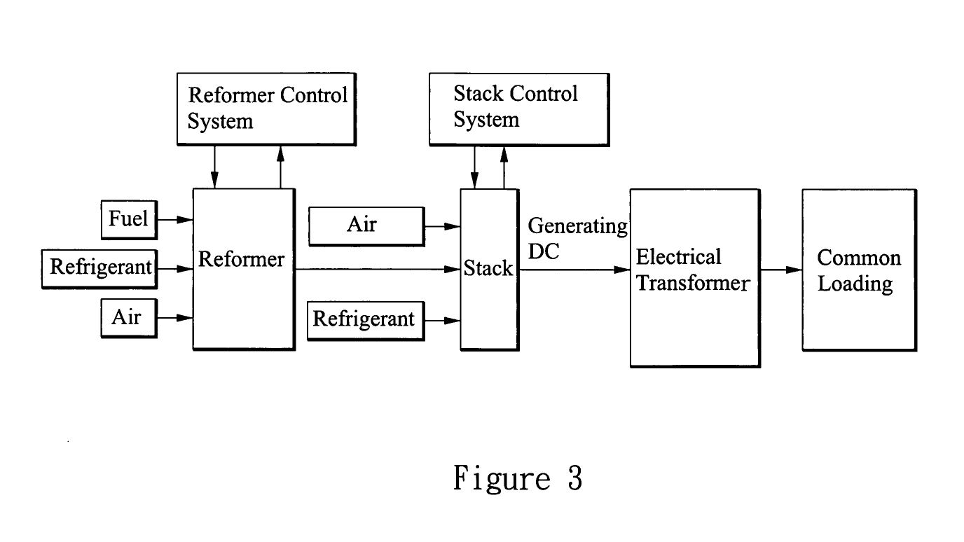

### DETAILED DESCRIPTION OF THE PREFERRED EMBODIMENT

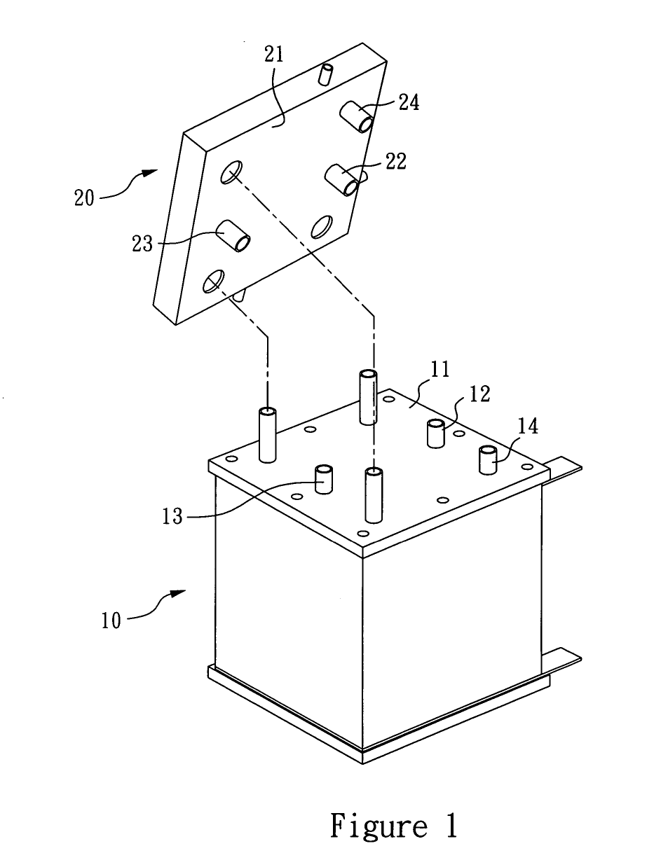

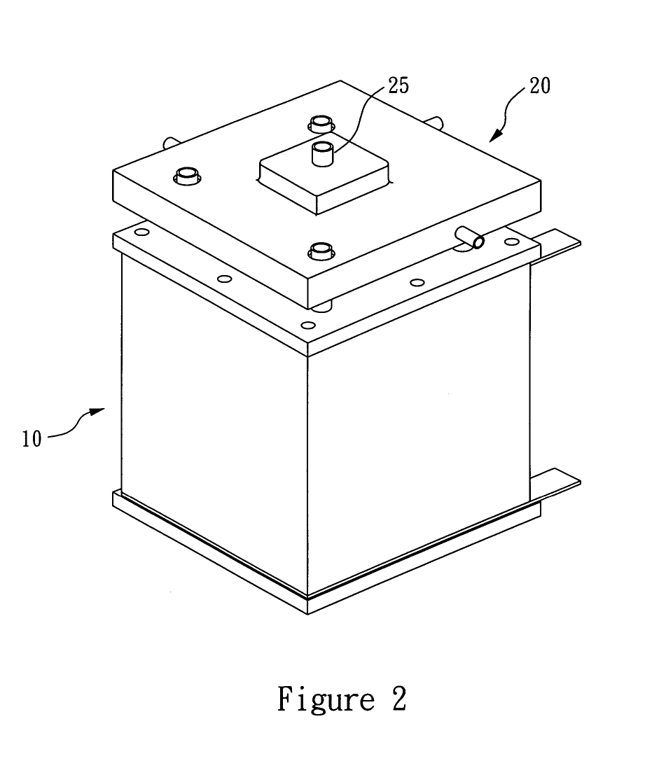

To better understand the structure and use of the present invention, firstly refer to FIG. 1, which is a preferred embodiment of the invention. The fuel cell of the present invention is formed by a stack 10 and a reformer 20. Coupling part 11 of the stack 10 and conjugate part 21 of the reformer 20 are both planar in shape. The conjugate part 21 of the reformer 20 may be coupled to the coupling part 11 of the stack 10. Referring to FIG. 2, it is shown that the stack 10 and reformer 20 may be coupled and integrated into a single entity to reduce the volume.

Referring to FIG. 1, first heat pipe 22 and second heat pipe 23 of the reformer 20 extend from the conjugate part 21. First introducer 12 and second introducer 13 of the stack 10 extend from the coupling part 11. The first introducer 12 of the stack 10 connects to the first heat pipe 22 of the reformer 20. Moreover, the second introducer 13 of the stack 10 connects to the second heat pipe 23 of the reformer 20. The heat produced by the reformer 20 during reaction may be transferred to the stack 10 via the first heat pipe 22 and first introducer 12. By doing so, the heat created by the reformer 20 during reaction transferred to the stack 10 provides the necessary working temperature to stack 10. The thermal energy is fully used to reduce expenses.

Referring to FIG. 2, fuel enters from gate 25 of the reformer 20 and is transformed into hydrogen by the reformer 20. Referring to FIG. 1, hydrogen pipe 24 of the reformer 20 extends from the conjugate part 21. Moreover, hydrogen intake pipe 14 of the stack 10 extends from the coupling part 11. The hydrogen pipe 24 of the reformer 20 connects to the hydrogen intake pipe 14 of the stack 10. Thus, hydrogen produced by the reformer 20 can be used by the stack 10.

Although the present invention has been explained in relation to its preferred embodiment, it is to be understood that many other possible modifications and variations can be made without departing from the scope of the invention as hereinafter claimed.

What is claimed is:

1. A fuel cell combining a stack and a reformer, comprising:
a stack having a coupling part; and
a reformer having a conjugate part wherein the conjugate part of the reformer is coupled to the coupling part of the stack.

2. The fuel cell combining a reformer and stack as claimed in claim 1, wherein said reformer comprises a first heat pipe and a second heat pipe; said stack comprising a first introducer and a second introducer; said first introducer connects to said first heat pipe; and the second introducer connects to the second heat pipe.

3. The fuel cell combining a reformer and stack as claimed in claim 1, wherein the said reformer comprises a hydrogen pipe extending to the conjugate part of the said reformer; said stack comprises a hydrogen intake pipe extending to the coupling part of said stack; and the hydrogen pipe and hydrogen intake pipe connect to each other.

4. The fuel cell combining a reformer and stack as claimed in claim 2, wherein the first heat pipe and second heat pipe of said reformer extend to the conjugate part of the said reformer; and the first introducer and second introducer of said stack extend to the coupling part of said stack.

5. The fuel cell combining a reformer and stack as claimed in claim 1, wherein the coupling part and conjugate part of the said stack and said reformer is planar in shape.

6. The fuel cell combining a reformer and stack as claimed in claim 1, wherein said stack and said reformer couple and integrate into a single unit.
